(19) United States
(12) Patent Application Publication
(10) Pub. No.: US 2026/0180691 A1
(43) Pub. Date: Jun. 25, 2026

(54) TECHNIQUES FOR IMAGE TRANSMISSION THROUGH ACOUSTIC CHANNELS IN UNDERWATER ENVIRONMENTS

(71) Applicant: RUTGERS, THE STATE UNIVERSITY OF NEW JERSEY, New Brunswick, NJ (US)

(72) Inventors: Dario POMPILI, Hillsborough, NJ (US); Muhammad Khizar ANJUM, Highland Park, NJ (US)

(21) Appl. No.: 19/127,139

(22) PCT Filed: Nov. 14, 2023
(86) PCT No.: PCT/US2023/079563

§ 371 Date: May 5, 2025

Related U.S. Application Data
(60) Provisional application No. 63/383,530, filed on Nov. 14, 2022.

(51) Int. Cl. H04B 13/02; G06N 3/08; G06N 20/00

(52) U.S. Cl. CPC H04B 13/02; G06N 3/08; G06N 20/00

(57) ABSTRACT

Techniques for underwater communications include training a model including a multilayer Convolution Neural Network (CNN) encoder and a multilayer CNN decoder and an underwater acoustic channel transform. A training set includes, for each of multiple instances, input image data and input acoustic channel information. The output of the model is output image data that is sufficiently similar to the input image data. First data that indicates the model is sent to a processor on an underwater device that comprises an underwater acoustic transceiver. The underwater device is configured to receive second data that indicates image data and input acoustic channel information data. The underwater device is further configured to generate third data that indicates output of the encoder of the first data operating on the second data. The underwater device is also configured to send the third data to the underwater acoustic transceiver for transmission into the underwater acoustic channel.

### CROSS-REFERENCE TO RELATED APPLICATIONS

This application claims benefit of Provisional Appl No. 63/383,530, filed Nov. 14, 2022, the entire contents of which are hereby incorporated by reference as if fully set forth herein, under 35 U.S.C. § 119 (c).

### STATEMENT OF GOVERNMENTAL INTEREST

This invention was made with government support under Contract No. 1763964 awarded by the National Science Foundation. The government has certain rights in the invention.

### BACKGROUND

The transmission of multimedia data such as text, images, audio and videos is useful and even enabling for those working in the field of underwater exploration, monitoring and operations as such data could provide vital information about the number, health and distribution of various species and machines in the underwater environment. However, such transmission is challenging because electromagnetic (radio and optical) systems have very limited range (on the order of tens of meters). The usage of the Underwater Wireless Optical Communication (UWOC) makes it possible to achieve high bandwidth within a communication distance of up to hundreds of meters. However, the UWOC suffers from water absorption and scattering effects caused by impurities in the water. Additionally, some alignments between the transmitter and receiver are required, and the quality of the communication link can be severely impaired by external factors, such as the presence of sources of reflection, e.g., bubbles. Acoustic signals traversing through an underwater acoustic channel are subject to low bandwidth and distortions due to varying interactions with the sea surface, varying interactions with the seafloor of varying depth, interference from other objects, varying acoustic noise, and varying sound channel conditions including temperature, salinity, currents and current shear. Thus, the underwater acoustic sound channel is non-stationary on time scales relevant to usual communication applications, including the duration of many audio and video transmissions.

The underwater acoustic channel is usually modelled as a Rician fading channel for short-range shallow water communication (with a depth of less than 100 m, where the power of the Line-of-Sight (LOS) signal is stronger than the multipath delay signals due to reflections from the sea surface, sea floor, or other objects) as a special case of Rayleigh and Rice models.

Because of acoustic channel variability, a system that uses one kind of coding and modulation scheme for representing images, audio or video will underperform over an extended period of time and hence an adaptive system is desired, which can change its coding or transmission parameters or both based on the current underwater acoustic channel conditions.

Most of the work towards realizing such an adaptive communication protocol has been directed towards optimizing source coding and channel coding separately, or rather optimizing parameters of hand-made codes, such as Joint Photographic Experts Group (JPEG) coding for imagery and Turbo coding for transmission, among others.

### SUMMARY

Techniques are provided for machine learning to devise advantageous representations of the multimedia source data based on the content of the source data or the conditions in the acoustic channel or both. Some of these techniques include an improvement on prior approaches to Joint Source-Channel Coding (JSCC).

In a first set of embodiments, a method for underwater acoustic communications, includes training automatically on a processor a model that comprises a multilayer convolution neural network encoder and an underwater acoustic channel transform and a multilayer convolution neural network decoder. The model is trained on a training set including, for each instance, input image data and input acoustic channel information data. The output of the model is output image data that is sufficiently similar to the input image data for a particular purpose. The method also includes sending first data that indicates the model to a processor on a underwater device that comprises an underwater acoustic transceiver. The underwater device is configured to receive second data that indicates image data and input acoustic channel information data. The underwater device is further configured to generate third data that indicates output of the encoder of the first data operating on the second data. The underwater device is also configured to send the third data to the underwater acoustic transceiver.

In some embodiments of the first set, the multilayer convolution neural network encoder further includes an encoding long short-term memory recurrent neural network and the multilayer convolution neural network decoder further includes a decoding long short-term memory recurrent neural network.

In some embodiments of the first set, each instance input image data depicts an underwater scene.

In some embodiments of the first set, each instance input acoustic channel information data indicates an amplitude shift and phase shift for each of one or more frequency shifts from a carrier acoustic frequency.

In some embodiments of the first set, each instance input acoustic channel information data indicates a numbered transceiver circuit tap for each of one or more frequency shifts from a carrier acoustic frequency.

In some embodiments of the first set, the underwater device is further configured to receive a second underwater acoustic signal that indicates fourth data, and configured to generate fifth data that indicates output image data based on output of the decoder of the first data operating on the fourth data.

In other sets of embodiments, a non-transient computer-readable medium or an apparatus or a system or a neural network is configured to perform one or more steps of the above methods.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1A is a block diagram that illustrates an example training set for machine learning;

FIG. 1B is a block diagram that illustrates an example automatic process for learning values for parameters of a chosen model during machine learning, according to various embodiments;

FIG. 2A is a block diagram that illustrates an example neural network 200 according to various embodiments;

FIG. 2B is a plot that illustrates example activation functions used to combine inputs at any node of a neural network, according to various embodiments;

FIG. 3 is a flow diagram that illustrates an example method for performing underwater acoustic communications, according to an embodiment;

FIG. 4 is a block diagram that illustrates examples of layers of a convolutional neural network (CNN) used to detect and encode features in underwater imagery, and then decode and combine them after transmission through an acoustic channel, which are jointly trained, according to an embodiment;

FIG. 5A is a block diagram that illustrates examples of a system comprising a CNN) feature extractor, a recurrent neural network (RNN) encoder for channel-aware compression used to detect and encode features in underwater imagery, and then decode and combine them after transmission through an acoustic channel, which are jointly trained, according to another embodiment;

FIG. 5B is a block diagram that illustrates example further details of a system like that depicted in FIG. 5A, according to an embodiment;

FIG. 5C is a block diagram that illustrates an example for a LSTM sequence-to-sequence compression encoder and decompression decoder for the system of FIG. 5B, according to an embodiment.

FIG. 6A and FIG. 6B are tables that list parameters used in experimental embodiments;

FIG. 7A through FIG. 7C are plots that illustrate examples of advantages over previous approaches, according to an embodiment;

FIG. 8 is a block diagram that illustrates a computer system upon which an embodiment of the invention may be implemented; and

FIG. 9 is a block diagram that illustrates a chip set upon which an embodiment of the invention may be implemented.

### DETAILED DESCRIPTION

A method and apparatus are described for using machine learning to detect and correct for variations in an underwater acoustic channel during underwater communications. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Some embodiments of the invention are described below in the context of communicating imagery or video source data through continental shelf sea water environments with bathymetric depths on the order of 100 meters (m) and modeled by Rician model for two or more submerged vehicles. However, the invention is not limited to this context. In other embodiments, the techniques used here apply to other source data, including communicating text or audio data or imagery or video or some combination of source data, through saltwater or freshwater environments with both deeper or shallower bathymetric depths, with more or fewer, autonomous, or remote controlled or human occupied, submerged vehicles.

### 1. Overview of Machine Learning.

In various embodiments, machine learning, a branch of artificial intelligence, is used to detect or correct for variations in the underwater acoustic channel available during underwater communications. In its most general form, machine learning involves a model M that has one or more adjustable parameters P. The model M accepts available data X to produce a desired result Y, represented by the equation Y=M(P,X), where X, Y and P are sets of one or more elements. During machine learning, a training set that includes both X values and Y values, based on simulations or past experience or domain knowledge, are used to set values for one or more otherwise uncertain values for the adjustable parameters P.

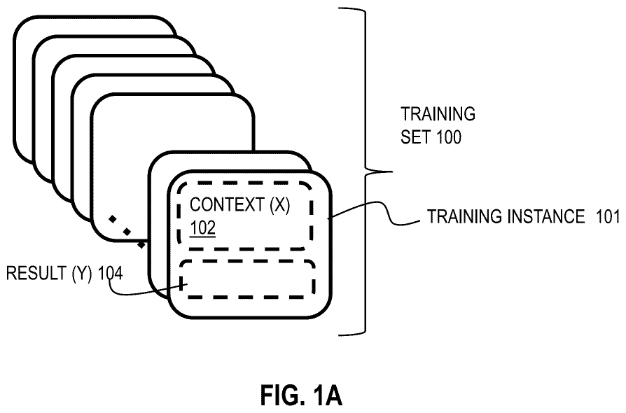

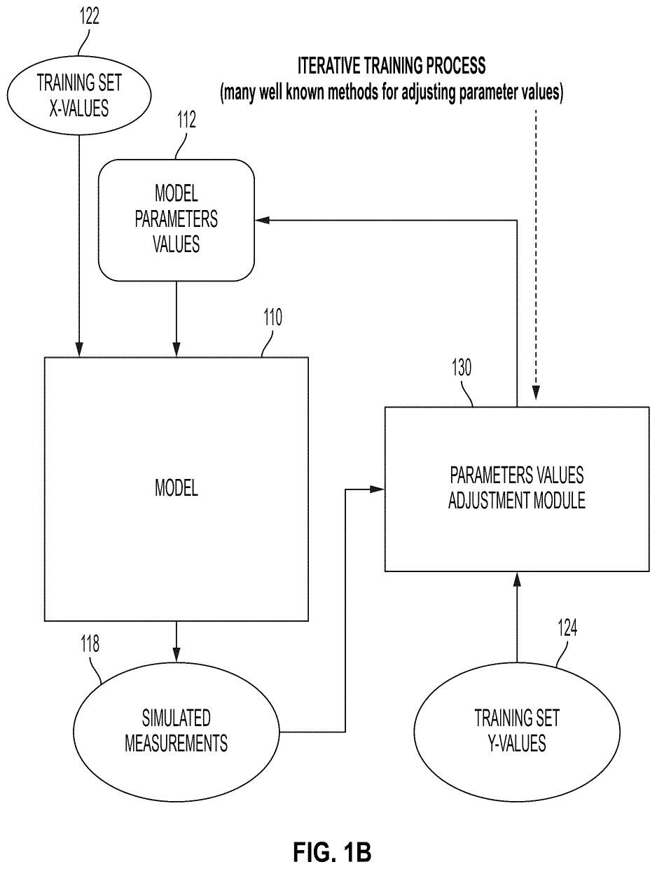

FIG. 1A is a block diagram that illustrates an example training set 100, according to an embodiment. The training set 100 includes multiple instances, such as instance 101. The instances 101 for the training set 100 are selected to be appropriate for a particular operational purpose such as a purpose of example embodiments described in a later section. Each instance 101 includes a set of values 102 for context variables X expected to be available as input to a learned process, and includes a set of one or more values 104 for result variables Y expected to be provided by the learned process.

During machine learning, a model M is selected appropriate for the purpose and data at hand. One or more of the model M adjustable parameters P is uncertain for that particular purpose and the values for such one or more parameters are learned automatically. Innovation is often employed in determining which model to use and which of its parameters P to fix and which to learn automatically. The learning process is typically iterative and begins with an initial value for each of the uncertain parameters P and adjusts those prior values based on some measure of goodness of fit of its Model output YM with known results Y for a given set of values for input context variables X from an instance 101 of the training set 100.

FIG. 1B is a block diagram that illustrates an example automatic process for learning values for uncertain parameters P 112 of a chosen model M 110 The model M 110 can be a Boolean model for a result Y of one or more binary values, each represented by a 0 or 1 (e.g., representing FALSE or TRUE respectively), a classification model for membership in two or more classes (either known classes or self-discovered classes using cluster analysis), other statistical models such as multivariate regression or neural networks, or a physical model, or some combination of two or more such models. A physical model differs from the other purely data-driven models because a physical model depends on mathematical expressions for known or hypothesized relationships among physical phenomena. When used with machine learning, the physical model includes one or more parameterized constants, such as seafloor reflection coefficients, that are not known or not known precisely enough for the given purpose.

During training depicted in FIG. 1B, the model 110 is operated with current values 112 of the parameters P, including one or more uncertain parameters of P (initially set arbitrarily or based on order of magnitude estimates) and values of the context variables X from an instance 101 of the training set 100. The values 116 of the output YM from the model M, also called simulated measurements, are then compared to the values 124 of the known result variables Y from the corresponding instance 101 of the training set 100 in the parameters values adjustment module 130.

The parameters values adjustment module 130 implements one or more known or novel procedures, or some combination, for adjusting the values 112 of the one or more uncertain parameters of P based on the difference between the values of YM and the values of Y. The difference between YM and Y can be evaluated using any known or novel method for characterizing a difference, including least squared error, maximum entropy, fit to a particular probability density function (pdf) for the errors, e.g., using a priori or a posterior probabilities. The model M is then run again with the updated values 112 of the uncertain parameters of P and the values of the context variables X from a different instance of the training set 100. The updated values 116 of the output YM from the model M are then compared to the values of the known result variables Y from the corresponding instance of the training set 100 in the next iteration of the parameter values adjustment module 130.

The process of FIG. 1B continues to iterate until some stop condition is satisfied. Many different stop conditions can be used. The model can be trained by cycling through all or a substantial portion of the training set. In some embodiments, a minority portion of the training set 100 is held back as a validation set. The validation set is not used during training, but rather is used after training to test how well the trained model works on instances that were not included in the training. The performance on the validation set instances, if truly randomly withheld from the instances used in training, is expected to provide an estimate of the performance of the learned model in producing YM when operating on target data X with unknown results Y.

Typical stop conditions include one or more of a certain number of iterations, a certain number of cycles through the training portion of the training set, producing differences between YM and Y less than some target threshold, producing successive iterations with no substantial reduction in differences between YM, and errors in the validation set less than some target threshold, among others.

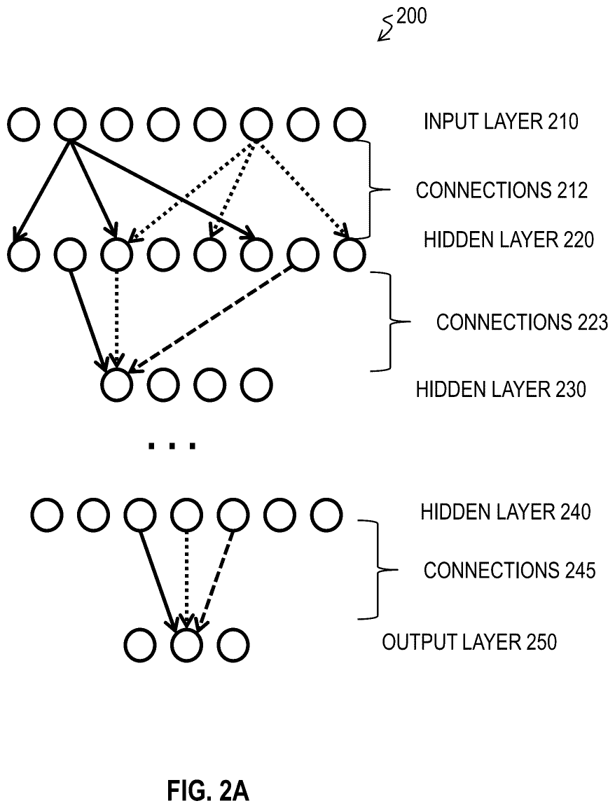

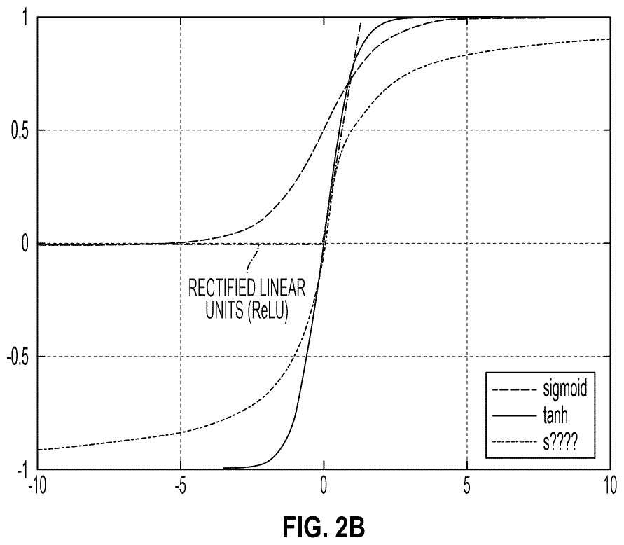

In some embodiments, the model M is a neural network, widely used in image processing and natural language processing. FIG. 2A is a block diagram that illustrates an example neural network 200, according to various embodiments. A neural network 200 is a computational system, implemented on a general-purpose computer, or field programmable gate array, or some application specific integrated circuit (ASIC), or some neural network development platform, or specific neural network hardware, or some combination. The neural network is made up of an input layer 210 of nodes, at least one hidden layer such as hidden layers 220, 230 or 240 of nodes, and an output layer 250 of one or more nodes. Each node is an element, such as a register or memory location, that holds data that indicates a value. The value can be code, binary, integer, floating point or any other means of representing data. In common forms of neural networks, values in nodes in each successive layer after the input layer in the direction toward the output layer is based on the values of one or more nodes in the previous layer. The nodes in one layer that contribute to the next layer are said to be connected to the node in the later layer. Example connections 212, 223, 245 are depicted in FIG. 2A as arrows. The values of the connected nodes are combined at the node in the later layer using some activation function with scale and bias (also called weights) that can be different for each connection. Neural networks are so named because their nodes and connections are modeled after the way neuron cells are connected in biological systems. A fully connected neural network has every node at each layer connected to every node at any previous or later layer or both.

FIG. 2B is a plot that illustrates example activation functions used to combine inputs at any node of a neural network. These activation functions are normalized to have a magnitude of 1 and a bias of zero; but when associated with any connection can have a variable magnitude given by a weight and centered on a different value given by a bias. The values in the output layer 250 depend on the values in the input layer and the activation functions used at each node and the weights and biases associated with each connection that terminates on that node. The sigmoid activation function (dashed trace) has the properties that values much less than the center value do not contribute to the combination (a so called switch effect, switching on when traversing the plot from left edge to center, and switching off when traversing the plot from center to left edge) and large values do not contribute more than the maximum value to the combination (a so called saturation effect), both properties frequently observed in natural neurons. The tanh activation function (solid trace) has similar properties but allows both positive and negative contributions. The softsign activation function (short dash-dot trace) is similar to the tanh function but has much more gradual switch and saturation responses. The rectified linear units (ReLU) activation function (long dash-dot trace) simply ignores negative contributions from nodes on the previous layer but increases linearly with positive contributions from the nodes on the previous layer; thus, ReLU activation exhibits switching but does not exhibit saturation. In some embodiments, the activation function operates on individual connections before a subsequent operation, such as summation or multiplication; in other embodiments, the activation function operates on the sum or product or other mathematical or logical or textual operation on the values in the connected nodes. In other embodiments, other activation functions are used, such as kernel convolution.

Some neural networks are used that remember past layer contents and are useful in feedback, recursive and accumulation circuits. Such networks are called recurrent neural networks (RNN). Long Short-Term Memory (LSTM) registers have been useful in implementing such RNN. LSTM networks are a type of RNN that has an internal state that can represent context information. They keep information about past inputs for an amount of time that is not fixed a priori, but rather depends on its weights and on the input data.

An advantage of neural networks is that they can be trained as a model M to produce a desired output from a given input without knowledge of how the desired output is computed. There are various algorithms known in the art to train the neural network on example inputs with known output, such as back propagation. The adjustable parameters P include the number of layers, the number of nodes in each layer, the connections, the operation at each node, the activation function and the weight and bias at each node. Typically, however, the number of layers, number of nodes per layer, the connections and the activation function for each node or layer of nodes is predetermined, and the training determines the weight and bias for each connection or at each node on each layer, so that weights and biases for all nodes constitute the uncertain parameters of P. A trained network that provides useful results, e.g., with demonstrated good performance for known results during validation, is then used in operation on new input data not used to train or validate the network.

In some neural networks, the activation functions, weights and biases, are shared for an entire layer. This provides the networks with shift and rotation invariant responses especially useful for identifying features, such as holes or objects, anywhere and oriented at any angle in an image. The hidden layers can also consist of convolutional layers, pooling layers, fully connected layers and normalization layers. The convolutional layer has parameters made up of a set of learnable filters (or kernels), which have a small receptive field, i.e., are connected to just a few nodes of the previous layer. In image processing the small receptive field is usually a few contiguous nodes in an area of an image represented by the previous layer, as in the visual system of an animal eye. In a pooling layer, the activation functions perform a form of non-linear down-sampling, e.g., producing one node with a single value to represent four nodes in a previous layer. There are several non-linear functions to implement pooling among which max pooling is the most common. A normalization layer simply rescales the values in a layer to lie between a predetermined minimum value and a predetermined maximum value, e.g., 0 and 1, respectively.

It has been found that neural networks of limited output layer size provide advantages in recognizing contents of images.

A method for machine learning includes selecting the training set, the variables that will serve as context input X and result output Y, a model M, and the model's certain (fixed) and uncertain (adjusted automatically during machine learning), parameters P_{F} and P_{L}, respectively, of model parameters, such that P=P_{F}∪P_{L}. The training set T is then divided into a training subset T_{T} with the majority of instances and a validation subset T_{V} with the remaining instances, such that T=T_{T}∪T_{V}. Values for P_{L} are determined by applying the method of FIG. 1B on the training subset T_{T}. The P_{L} values are validated by using them on the validation set T_{V}, provided that the differences between Y_{M} and the Y for the validation set T_{V} is acceptably small, e.g., have mean square error (MSE) less than a desired threshold or have a distribution that satisfies desired characteristics, e.g., maximum entropy. If not validated, then control returns to earlier steps to revise the training set T, e.g., by acquiring more instances, or revising the model M, or revising the set of adjustable parameters P_{L} or some combination. If validated, then the model is used with the current values for P, on new operational data, Xo to produce operational results Yo. In some embodiments, where Yo can be subsequently or eventually observed to be Yod, the values of Xo and Yod are randomly or consistently added to the training set T and the parameters P_{L} are updated using a new subset of T_{T} of the updated T.

### 2. Joint Source Code and Channel Code Machine Learning for Underwater Acoustic Communication of Images

Machine learning applied to the underwater transmission problem includes training a model M so that both the encoding of source data and the number of features to transmit are controlled by the conditions in the acoustic channel used as acoustic context values XA, as characterized, for example, by the signal to noise ratio (SNR). This is a new kind of deep learning called Joint Source-Channel Coding (JSCC).

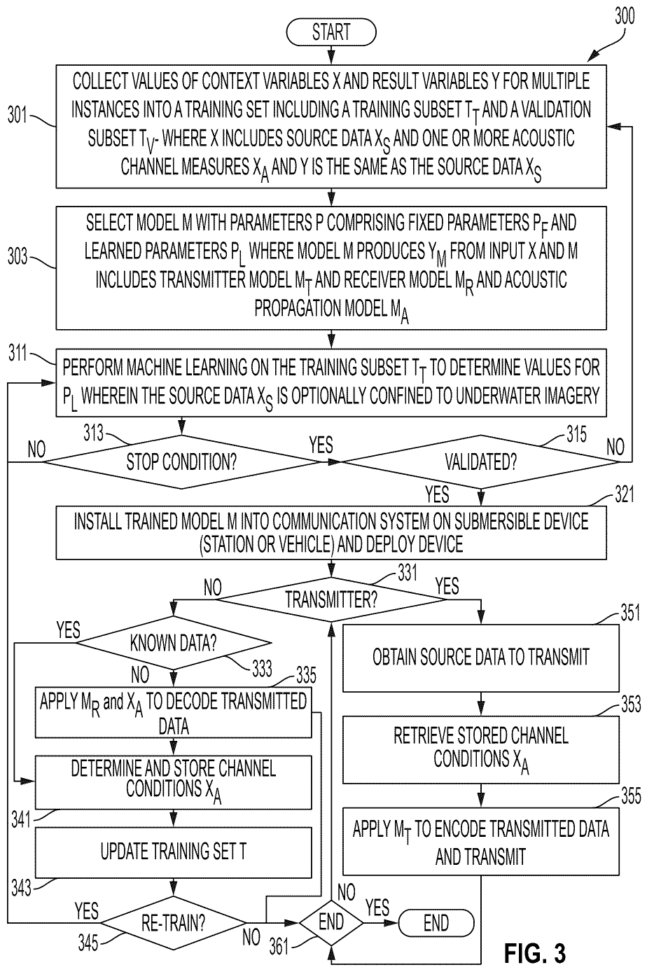

The model M is used to communicate through the underwater acoustic channel so that the received data Y is about the same as the transmitted source data (e.g., text, image, audio, video), in the training set T. Thus, X includes X_{S} and X_{A}, where X_{S} is the source data and X_{A} is the acoustic channel information, e.g., X=X_{S}∪X_{A}. Thus, in each instance of the training set Y=X_{S}. The model M includes a transmitter model M_{T} and a receiver model M_{R} and an acoustic channel distortion model M_{A}, so M=M_{T}∪M_{A}∪M_{R}. M_{T} is used to convert X to a form Y_{T}=M_{T}(P_{T}, X), where P_{T} are the learned parameters of the transmitter model M_{T}, so that Y is suitable for transmitting through the acoustic channel prior to transmitting. M_{R} is used to convert the received data X_{R}=M_{A}(P_{A}, X_{S}, Y_{T}), where P_{A} are the learned parameters of the acoustic channel model M_{A}, into a best achievable approximation of the source data Y_{M}=M_{R}(P_{R}, X_{R})=X_{S}, where P_{R} are the learned parameters of the receiver model M_{R} In many embodiments, the received signal X_{R} can be used to derive properties of the acoustic channel X_{A}. All uncertain parameters of the model M, including P_{T}, P_{A} and P_{R} are learned together, i.e., joint machine learning. Such embodiments for underwater acoustic communications use a method depicted in FIG. 3.

FIG. 3 is a flow diagram that illustrates an example method for performing underwater acoustic communications, according to an embodiment. Although steps are depicted in FIG. 3 as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In step 301, values of context variables X and result variables Y for multiple instances are collected into a training set T including a training subset Tr and a validation subset T_{V}. Here X includes source data X_{S}, such as an image, video, audio, text, vector of drawing features, and X includes one or more acoustic channel measures X_{A}, also called Channel State Information (CSI) in example embodiments, such as noise, attenuation, frequency shifts, or Rician channel feature values such as water depth or multipath delays or relative amplitudes, or decorrelation times, or some combination. In some embodiments CSI is determined based on feedback measured from known transmitted signals called pilot symbols. Here Y, the desired output, is the same as the source data X_{S}.

In step 303, a model M is selected, where M includes parameters P comprising fixed parameters P_{F} and learned parameters P_{L} where model M produces Y_{M} from input X and M includes transmitter model M_{T} and receiver model M_{R} and acoustic propagation model M_{A}.

In some embodiments described in the examples section, the transmitter model M_{T} includes a feature extraction module, such as a convolution neural network (CNN) with weights and biases included in the P_{L}, and includes a feature encoder, such as a long Short-Term memory (LSTM) encoder with weights and biases included in the P_{L}, that produces an encoded vector for transmission based on the features and the CSI, and includes a mapping module to map the encoded vector into a transmission for broadcast by the transmitter. As a complement, in such embodiments, the receiver model M_{R} includes a demapping module to derive the encoded vector from a transmission received by a receiver, a feature decoder, such as a long Short-Term memory (LSTM) encoder with weights and biases included in the P_{L}, that produces an acceptable facsimile of the features based on the received encoded vector and the CSI, and includes a source reconstruction module, such as a convolution neural network (CNN) with weights and biases included in the _{PL} to output an acceptable representation of the source X_{S}. In some embodiments, the acoustic propagation model M_{A} is fully described by the acoustic channel measures X_{A}, e.g., the CSI, as determined by the detected distortions of the received pilot symbols and a physics based propagation model such as the Rician model. in some embodiments, the acoustic model incorporates learned parameters based on both the training data (images) and the channel conditions, which is why it is able to encode the images more efficiently. At runtime, it is specified both (an image to transmit) and channel conditions X_{A}. In some embodiments, the mapping and demapping modules (numbered as elements 518 and 538 in the pptx) do not have any learned parameters P_{L}.

In step 311, machine learning is performed using the training subset Tr to determine values for P_{L}. In some embodiments, the propagated vector considered to be received at the receiver and subsequently input to the receiver model M_{R} is not a measured vector but a simulated vector based on the transmitted vector and the acoustic propagation model M_{A} fully determined by the acoustic channel measures X_{A}. In some embodiments, the propagated vector subsequently input to the receiver model M_{R} is in fact a measured received vector determined during underwater experiments, included in the context information for the training set, or updates thereto, and associated with the acoustic channel measures X_{A}. Both kinds of training are possible, simulated and experimental. Experimental training on-the-fly can enable domain adaptation (to the channel conditions at hand) during operations, leading to more efficient transmission/reception. In the example embodiments described in the next section, the source data X_{S} in both the training set and the operational use is confined to underwater imagery, e.g., omitting video, audio, text and drawing vectors.

In step 313, it is determined if a model M training stop condition has been reached, such as any of the stop conditions described above with respect to machine learning, or some combination. Recall that typical stop conditions include one or more of a certain number of iterations, a certain number of cycles through the training subset Tr of the training set T, producing differences between Y_{M} and Y less than some target threshold, producing successive iterations with no substantial reduction in differences between Y_{M}. If it is determined that the stop condition is not yet satisfied, control passes back to step 311 to continue with machine learning for model M.

If it is determined in step 313 that the stop condition is satisfied, then control passes to step 315 to determine whether the trained model M is validated. Any method may be used to validate the trained model M, such as differences between the model output Y_{M} and the source X_{S} is acceptably small, as measured by maximum or average differences or a random distribution of differences. If it is determined that the model M is not yet validated, control passes back to step 301 to expand the training set T and continue with machine learning for model M.

If it is determined in step 315 that the model M is validated, then control passes to step 321. In step 321, the trained model M is installed into a communication system on submersible device (e.g., an underwater monitoring station or manned or unmanned vehicle) with an acoustic transceiver. The submersible device is then deployed into an underwater environment. The communication system on the submersible device is then operated according to a portion of the method described by steps 331 to 361.

In step 331, the communication system on the submersible device determines whether it is to operate its acoustic transceiver as a transmitter. If so, control passes to step 351, described below. If not, then the communication system operates the acoustic transceiver as a receiver and control passes to step 333.

In step 333, the communication system determines whether it is receiving known data, such as one or more pilot symbols that are transmitted on occasion by other surface or submersible devices or a return of a previous message transmitted. If so, then control passes to step 341. In step 341 the properties of the received known data, such as one or more test images or pilot symbols, is used to determine channel conditions, i.e., values of one or more acoustic channel measures X_{A}. These values are stored by the communications system as representative of current in time channel conditions in the vicinity of the submersible device. Control then passes to step 343.

In step 343, the training set T (training subset T_{T} or validation subset T_{V}) is updated based on the known data and the actual received data and the derived acoustic channel measures X_{A}. In step 345 it is determined whether the model M should be retrained, e.g., after the submersible is retrieved and compared to the known data sent. If so, control passes back to step 311 and following described above. If not, control passes to step 361. In some embodiments, step 343 is omitted and control passes from step 341 to step 361.

In step 361, it is determined whether conditions to end acoustic communications are satisfied, such as when the submersible device resurfaces and is in contact with the air for resumption of radio communications. If so, the process ends. Otherwise, control passes back to step 331, described above.

If it is determined in step 333 that the communication system is NOT receiving known data, such as one or more pilot symbols, then control passes to step 335. In step 335 the trained receiver model M_{R} and the currently stored derived acoustic channel measures X_{A} (derived in step 341) are used to reconstruct an acceptable facsimile Y_{M} of the transmitted source X_{S}. The reconstructed facsimile Y_{M} is then used by the submersible device for whatever purpose the transmitted source X_{S} was intended, such as to initiate capture or evasion maneuvers. Control then passes to step 361 to determine whether to end acoustic communications, as described above.

If it is determined, in step 331, that the communication system operates the acoustic transceiver as a transmitter then control passes to step 351. In step 351, source data X_{S} to be transmitted is obtained, e.g., from an underwater camera or environmental sampler on the submersible device or known or predetermined data such as pilot symbols used to assess acoustic channel measures X_{A}. In step 353, stored values for the acoustic channel measures X_{A} (derived in step 341) are retrieved. In step 355, transmitter model M_{T} and retrieved acoustic channel measures X_{A} are applied to determine one or more features therein, to encode those features as a vector and to map the vector for broadcast by the transmitter, e.g., using Orthogonal Frequency-Division Multiplexing (OFDM). The mapped vector is then transmitted using the protocol for the acoustic channel, e.g., OFDM. Control then passes to step 361 to determine if end conditions are satisfied, as described above.

The advantages of various embodiments of the method 300 include one or more of the following.

Adaptive Communication Based on Image Content and Channel State Information. Various embodiments uniquely combine the content of the image with CSI to adapt its communication protocols. This dual consideration ensures efficient data transmission tailored to both the data's nature and the current channel conditions. This technology is crucial for real-time underwater monitoring systems, where timely and accurate data transmission is paramount. It can be applied in early warning systems, marine life tracking, and underwater exploration missions.

Online Learning and Training for Robust Image Transmission. In the challenging domain of underwater acoustic image transmission, online learning and training offer a dynamic solution. This approach involves the continuous adaptation and updating of transmission models based on real-time underwater data, e.g., in steps 343 and 345 of method 300. Unlike static models, online learning adjusts to the ever-changing conditions of underwater environments, such as varying water turbidity, temperature fluctuations, and marine life interference. The adaptive nature of online learning is especially beneficial for underwater exploration missions, where timely and accurate image transmission can be crucial for decision-making. It can be employed in Autonomous Underwater Vehicles (AUVs) to adaptively adjust their image transmission protocols based on current conditions, ensuring clear visuals for researchers. Marine biologists tracking and studying marine life can benefit from clearer, real-time images that online learning can facilitate. Additionally, in underwater archaeological expeditions, where the clarity of transmitted images can be the difference between identifying a significant artifact and overlooking it, online learning can play a pivotal role. Further, defense and security operations, which might require stealthy and clear image transmissions in diverse underwater conditions, can leverage this approach for favorable results.

CNN-centric Method for Feature Extraction. Some embodiments utilize a unique method that employs Convolutional Neural Networks (CNNs) tailored specifically for extracting features from underwater imagery. This method is designed to capture the nuances and challenges posed by underwater environments, such as murkiness and particulates. This technology can be applied to any system requiring efficient and accurate image recognition and processing in underwater settings, such as marine research, underwater vehicle navigation, and environmental monitoring.

LSTM-integrated Source-Channel Encoder. In some embodiments, a novel encoder that integrates Long Short-Term Memory (LSTM) networks is used. Unlike traditional methods that predict a constant-sized vector for transmission, this encoder produces variable-length sequences. These sequences adapt to both the content of the image and the Channel State Information (CSI), optimizing data transmission based on current conditions. This encoder can be pivotal in adaptive underwater communication systems, especially in environments with fluctuating conditions. It can be used in underwater drones, communication between submerged devices, and data relay systems in marine research.

Data-Driven Scheme for JSCC in Underwater Acoustic Channels. Various embodiments include a data-driven scheme for Joint Source-Channel Coding (JSCC) specifically tailored for underwater acoustic channels. Some embodiments combine CNN-based feature extraction with a novel variable-length encoder and decoder design based on RNNs. This scheme can revolutionize underwater data transmission, especially in scenarios requiring high data fidelity and efficiency. Potential applications include deep-sea exploration, underwater archaeological studies, and marine conservation efforts.

### 3. Example Embodiments

Example experimental embodiments are described here for image data.

### 3.1 Example Structures

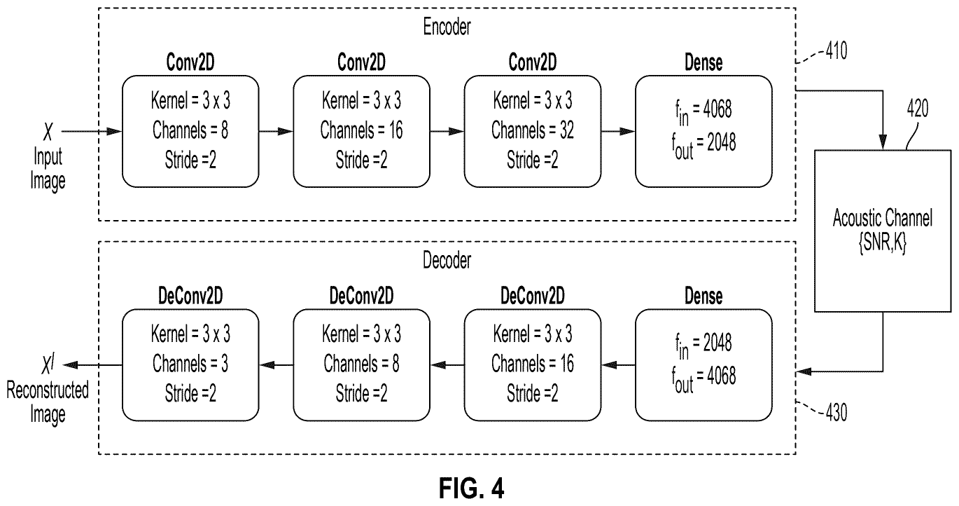

In some embodiments, a Convolutional Neural Network (CNN) structure is used as at least one portion of the transmitter model, M_{T}, also called a feature encoder herein; and, another CNN structure is used as a least one portion of the receiver model, M_{R}, also called a feature decoder herein. The feature encoder and feature decoder extract and combine, respectively, useful and important features out of the images to be communicated, as illustrated in FIG. 4. FIG. 4 is a block diagram that illustrates examples of layers of a convolutional neural network (CNN) used to detect and encode features in underwater imagery, and then decode and combine them after transmission through an acoustic channel, which are jointly trained, according to an embodiment. In this embodiment, the transmitter model M_{T} of model M comprises feature encoder 410; and the receiver model M_{R} of model M comprises feature decoder 430.

As further illustrated in FIG. 4, the model M includes a physics-based transform portion M_{A} 420 that models the effect by the acoustic channel on the transmission of the coded feature data based on information about channel conditions. The efficiency of such feature extraction is enhanced, in some embodiments, by confining the training set source data X_{S} to only underwater images, which are expected to be a primary source of bandwidth hungry new information about underwater operations. The training is also enhanced by including as context variables X_{A} information about the acoustic channel conditions which affects the operation of the physics-based portion M_{A} 420 of model M. Thus, because of the joint training, a different feature set may be extracted under different acoustic channel conditions. In the illustrated embodiment, the acoustic channel is characterized by X_{A} parameters that describe signal to noise ratio (SNR) and the gain factor (K) that must be compensated at the receiver by appropriate electronic circuitry. Several such appropriate circuits are engaged by corresponding contacts called “taps” selected by an operator of the receiving equipment.

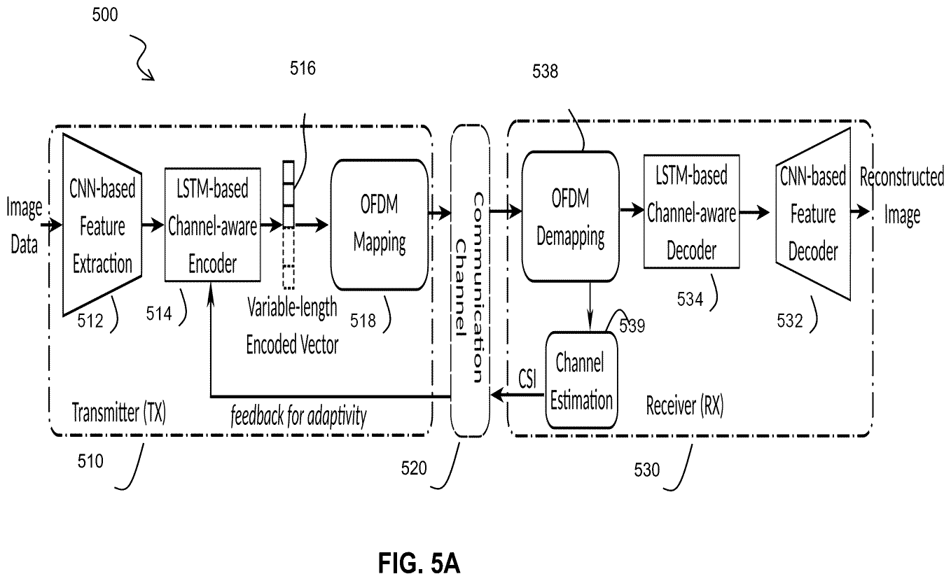

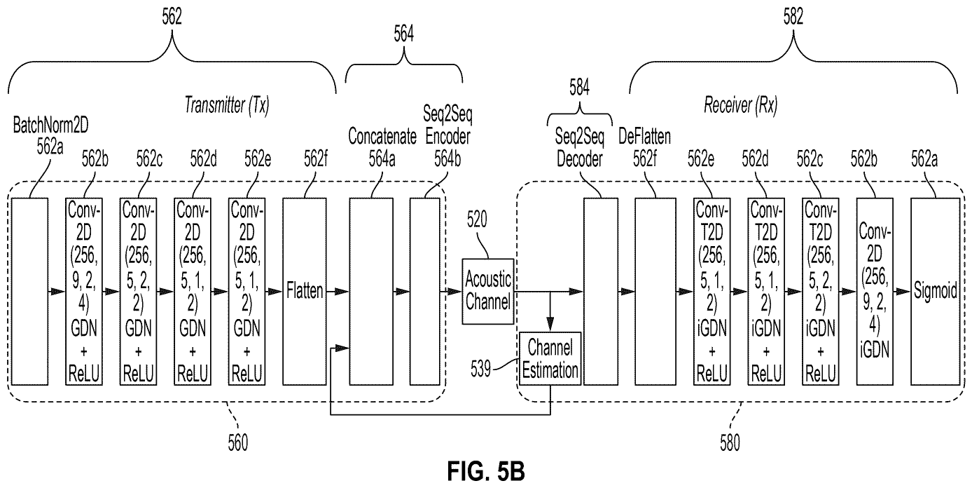

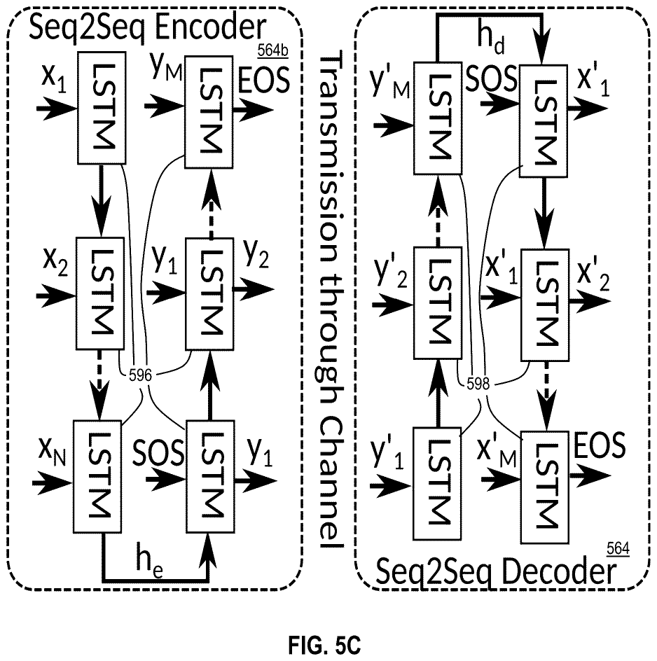

In yet other embodiments, the feature encoder of FIG. 4 is replaced by a CNN feature extraction module and a RNN encoder, the latter providing acoustic-channel-dependent feature compression as depicted in FIG. 5A. FIG. 5A is a block diagram that illustrates an example of a system 500 comprising a CNN feature extractor, a recurrent neural network (RNN) encoder for channel-aware compression used to detect and encode features in underwater imagery, and then decode and combine them after transmission through an acoustic channel, which are jointly trained, according to another embodiment. In this embodiment, the transmitter module 510 embodies Model M_{T}, the communication channel 520 is modeled by model M_{A} tuned by the values for SNR and gain K, and the receiver module 530 embodies model M_{R}. This particular embodiment for image data is called Joint Source-Channel Coding (JSCC).

The JSCC transmitter module 510 includes CNN module 512 for feature extraction from image source data as X_{S}, a encoder module 514 for compression of features based on acoustic channel conditions by posing such feature compression as a translation problem and using sequence-to-sequence learning to solve it, which is the first time it has been utilized for this application. This feature compression encoder module 514 takes the form of long short-term memory (LSTM) registers arranged in a recurrent neural network (RNN) as described in more detail below. Such extra LSTM RNNs are added, one each, to the transmitter module M_{T} 510 as encoder 514 and the receiver model M_{R} 530 as decoder 534 . . . . The output of the encoder module 514 is a variable length compressed vector (also called encoded vector) in register 516 whose length depends on the LSTM encoder module 514 and the acoustic channel properties indicated, for example, by values of X_{A} parameters SNR and K. The compressed vector in register 516 is then mapped to the acoustic communication protocol such as OFDM in mapping module 518. Complementary modules appear in receiver module 530 embodying M_{R}. These complementary modules include demapping module 538 that takes in a received signal using the communication protocol, such as OFDM, and outputs a variable length vector (not shown) that is decompressed by LSTM decoder 534 based at least in part on channel properties indicated, for example, by values of X_{A} parameters SNR and K to output features that are combined in CNN feature combining module 532 (also called CNN-based feature decoder) to produce reconstructed image data.

As explained above, acoustic channel measures X_{A}, aka Channel State Information (CSI), is determined by the receipt of known data such as pilot symbols. Channel estimation module 539 in receiver module 530 derives the values of the CSI from the received information in one of two ways. In one approach pilot symbols are received and used to deduce the CSI. In some embodiments this information is conveyed back to the transmitter module on the other device as pilot symbols, as indicated by the CSI arrow directed to the communication channel 520 in FIG. 5A. In another embodiment, the known information is the mapped information sent in a previous transmission to the other device. Receiving the mapped information back from the other device then constitutes the known data from which the values of the CSI can be deduced by Channel estimation module 539, and added to the training set for further training or validation. In such embodiments, the arrow labeled CSI directed to the communication channel indicates the protocol mapped information received from the transmitter 510, transmitted by the receiver 530 back to the transmitter 510. Since the transmitter 510 knows the information it sent, the transmitter 510 can determine the properties of the channel 520 and hence the CSI for use in the channel aware compression encoder 514. The deduction of CSI can be done either at the receiver or transmitter. It is preferably done at the receiver because sending back all the data it received is inefficient compared to just the sending the CSI. Furthermore, in some embodiments one sends only some features (delay spread, signal-to-noise ratio, coherence time, etc.) of the CSI back to the transmitter to save more on bandwidth.

FIG. 5B is a block diagram that illustrates example further details of a system 501 like that depicted in FIG. 5A, according to an embodiment. FIG. 5A assumes the vector register 516 and OFDM mapping and demapping modules 518 and 538, respectively, to avoid cluttering the block diagram. FIG. 5B depicts example specific layers of the CNN feature extraction module 562 as comprising 6 hidden layers. A first layer 562a normalizes the 2D image data. The next four layers 562b, 562c, 562d, 562e, respectively, are 2D convolutional layers with output channels, kernel size, stride and padding specified for each. These convolutional layers include Generalized Divisive Normalization (GDN) with ReLU activation. The final layer 562f flattens the data to serve as input for the next module.

The next module is an example specific feature compression encoder module 564 embodiment of feature compression encoder module 514. The feature compression encoder module 564 includes a concatenation layer 564a that concatenates the output of the CNN feature extraction module 562 with values of the CSI, such as SNR and gain K. The feature compression encoder module 564 also includes LSTM Seq2Seq compression encoder 564b, described in more detail below with reference to FIG. 5C.

The receiver module includes complementary layers for feature decompression decoder module 584 and feature combining module 582. The latter includes corresponding layers 582b, 582c, 582d, 582e, respectively, which are 2D convolutional layers with output channels, kernel size, stride and padding specified for each. These convolutional layers include inverse GDN (iGDN) with ReLU activation. The final layer of feature combining module 582 is a sigmoid layer 582a using the sigmoid activation to output the reconstructed image.

Details of the LSTM portions of the compression encoder 564 and decompression decoder 584, respectively, are depicted in FIG. 5C, described in more detail below. Next is described the justification and function for the details in teh CNN feature extraction and combination modules depicted in FIG. 5B.

Given the nature of underwater data, the images taken underwater vary considerably in their nature. A vast number of images in the underwater scene are unclear as the water is either muddy or has a number of particles suspended in it. Furthermore, such passive photography is only possible in shallow water as natural light rapidly scatters when entering the water through the surface. Furthermore, a vast majority of underwater images have large parts of the images containing only water, or plain background. This presents an opportunity to extract and compress the underwater images accordingly, e.g., by first extracting the features and then using them to unequally code different parts of the image.

A CNN feature extraction encoder E extracts the important parts of the image in an unsupervised manner. The architecture of the CNN-encoder is illustrated in detail in FIG. 5B. It consists of first a batch-normalization layer 562a, which is then followed by a convolution layer 562b with Generalized Divisive Normalization (GDN), and Rectified Linear Unit (ReLU) activation. This block is then repeated three more times in layers 562c, 562d, 562e, respectively, with slightly different parameters, as shown in FIG. 5B. Finally, the flatten layer converts the features from a matrix of size (C,H,W) to size (C,H×W), where C is the number of channels in the last layer, and H and W denote the height and width of the resulting features. The final encoded representations are then passed through an LSTM-based JSCC compression encoder which generates variable-length latent-vector encodings given the feedback CSI of the channel. After going through the LSTM-based JSCC compression encoder, the signal is also quantized to INT8 representation to be then mapped into a given protocol scheme (based on CSI) and transmitted over the acoustic channel. The parameters for the Orthogonal Frequency-Division Multiplexing (OFDM)-based transmission are also estimated using another feed-forward network which determines the mode of transmission of the image.

Subsequently, the receiver module 580 receives quantized and distorted representations to be restored. The feature combining decoder module 582 is designed as an inverse multi-scale transform network that is also composed of multiple convolutional layers. The feature combining decoder module 582 consists of a deflatten layer 562f, and then four deconvolutional blocks, 562e, 562d, 562c, 562b, finally resulting at layer 562a in the reproduction of the original image. In layer 562 ft, the decompressed vector is de-flattened from (C,H×W) to (C,H,W), and then each deconvolutional block executes transposed-convolutional layer, followed by inverse-GDN and ReLU activation. The last layer 562a of the feature combining decoder module 582 uses Sigmoid as the activation function, which is interpreted as an image.

One of the main drawbacks of regular deep neural-network-based JSCC schemes is that they predict a constant-sized vector to be transmitted through the channel. Here input (from feature extraction encoder E module 512 or 562) is considered as a pseudo-sequence of embedded features from the image concatenated with information from receiver-side about the channel (CSI). Features from CNN of the size (C,H×W) are first considered as a sentence of C words of embedding dimension H×W. Then this representation is extended in two ways: i) the embedding dimension is extended by adding SOS (start of sentence) and EOS (end of sentence) tokens on the first and last indices, making the new feature dimensions (C,H×W+2), and ii) the CSI of size (NP,NF FT), where NP is the number of pilot packets and NF FT is OFDM FFT size, is transformed to (NP,H×W+2) using a dense neural network. Finally, both sources of information are concatenated and have a final pseudo-sequence of size (C+NP,H×W+2). In order to feed this pseudo-sequence to the LSTM model, another dense layer is used to map onto the size (C+NP,h), where h is the hidden-size of the LSTM-layer. A sequence-to-sequence model (Ilya Sutskever, Oriol Vinyals, and Quoc V. Le. 2014.) is then applied to learn to transform this pseudo-sequence to another one which is robust to the channel. Just as languages have redundancy and have the ability to correct themselves in the presence of noise, it is expected this approach translates multi-scale features of the source image into a language that is redundant enough to correct itself given the current channel conditions. Since a larger redundancy usually corresponds to a lengthier sentence, a trade-off is expected in terms of channel conditions and length of the latent vector, i.e., the worse the channel conditions, the longer the code-word to recover from the expected distortion.

This architecture is shown in FIG. 5C. FIG. 5C is a block diagram that illustrates an example for a LSTM 596 sequence-to-sequence compression encoder 564b and a LSTM 596 sequence-to-sequence decompression decoder 584 for the system of FIG. 5B, according to an embodiment. Based on the Recurrent Neural Network (RNN)'s internal state determined by arrays of LSTN registers 590, it is decided if input sequence x1 through xN should produce more code words y1 through yM of hidden-size h to be output or if the sequence is finished. In this way, the final code-word has a length of L=Mh, where M differs for each channel condition and is learned during back-propagation joint training. At the decompression decoder module 584, the received message (which is distorted due to the channel multi-path effects) is passed through the network of LSTM registers 598, which performs the reverse translation task, i.e., converts the received message back to the multi-scale features then used by the feature combining decoder module 582 to reconstruct the image. This network is also expected to perform as a channel decoder, i.e., correct errors in the received message by using redundancy as encoded by the RNN compression encoder module 564 on the transmitter side.

For the following experimental embodiments, h is equal to 1024 and H=W=50 for an image-size of (200, 200, 3). SOS (Start Of Sequence), and EOS (End Of Sequence) are standard tokens used in sequence-to-sequence neural network literature for indicating start and end of a sequence being decoded by the network. These are just there for LSTM operation and are not transmitted or used further in the CNN decoder part. SOS prompts the LSTM to start decoding, while EOS is output by the LSTM to indicate that it has finished decoding.

Pilot symbols are known symbols that the receiver uses to determine channel tap gains, which contribute to CSI. The ratio of data symbols to pilot in a frame is set to ensure at least some pilot symbols during a channel coherence time interval. Use of pilot symbols becomes costly and unfeasible to track channel changes if channel coherence time Tc decreases too much because this leads to a lower ratio and thus a lower throughput.

In various embodiments, the acoustic channel information X_{S} that affects the M_{A} portion of the model M, includes one or more of an observed channel signal to noise ratio (SNR) and Channel State Information (CSI) data, either observed directly by the transmitter or conveyed in a separate text message from the receiver. This information either constitutes or is processed to provide the X_{A} portion of the context vector X. In some embodiments, the CSI data includes a complex number, indicating amplitude gain (negative gain indicates loss) and phase shift by the real and imaginary parts, for each of one or more acoustic frequency shifts from a carrier acoustic frequency. Experience has associated such amplitude and phase shifts with correction circuits, each accessed by a different numbered tap of a transceiver device. Such taps are well known for any acoustic transceiver system. Thus, in some embodiments, the CSI data is a tap number for each of one or more acoustic frequency shifts from the carrier acoustic frequency.

### 3.2 Example Training

In some embodiments, while training (either offline before deployment, or online re-training), the features are transmitted/received using complex channel gains collected during live experiments, thereby making the neural network aware of the observed channel conditions. In some embodiments, the channel is characterized using probability distribution functions (PDFs) like Rayleigh or Rician Random variables first, and using these characterizations to expand the space of limited channel observations that could be obtained from live experiments (channel augmentation), e.g., to account for physical perturbations (wind, waves, seasons, etc.) based on known physical models and spatial changes. Using these characterizations, the neural network could be trained for a wide variety of channel conditions (this likely increasing its generalization capability). In some embodiments, the estimated channel gains at the receiver, denoted by CSI, are sent back to the transmitter for variable length transmissions, as described above. The receiver estimates the channel tap gains for each pilot symbol, making the final size of channel estimates for one transmission protocol Orthogonal Frequency-Division Multiplexing (OFDM) frame equal to (FFT_size, num_pilot_symbols). For data-symbols this information is linearly interpolated. At the LSTM encoder/decoder, this information is first reshaped properly, concatenated with the parameter sequence, and then finally fed into the compression encoder module 564.

In order to train this multi-component neural network-based approach, a complex loss function and training process is employed to ensure correct training of the network. This loss function is composed of four components in total, which are then added together to compose an aggregate loss function to be optimized. In these components, the first component is the Mean Squared Error (MSE) of the encoder-decoder network defined by Equation 1.

$${L}_{MSE} ( y , \hat{y} ) = \frac{1}{H \times W} {\sum }_{i = 1}^{N} {( {y}_{i} - {\hat{y}}_{i} )}^{2} \qquad ( 1 )$$

where yᵢ and ŷᵢ are the i-th pixels of the input image y and reconstructed image ŷ respectively. H and W denote the height and width of the image respectively.

The second component of the loss function consists of the structural similarity index (SSIM) (Zhou Wang, A. C. Bovik, H. R. Sheikh, and E. P. Simoncelli. 2004). This metric is based on the assumption that human vision perceives structural information in a scene more robustly than the individual pixels. For this reason, it is modelled using luminance, contrast and structure common between two images (ground truth and reconstructed image). The structure is modeled using covariance matrix of both images. This metric is added into the loss function as well, because MSE alone is a poor indicator of how useful and clear an image is. Furthermore, the multi-scale version of this metric (MS-SSIM) is used, which is defined in the range [0, 1], and is directly proportional to image quality. In order to use it as a loss function, Equation 2 defines this contribution.

$$L ( y , \hat{y} ) = 1 - MSSIM ( {y}_{i} , \hat{y} ) \qquad ( 2 )$$

The third component of our proposed loss function concerns itself with the length of the code-word generated for transmission across the channel. This component depends on two major factors: i) the length of the code-word transmitted through the channel must be as short as possible to facilitate the highest rate at which data can be transmitted, but at the same time, ii) the features must also be reconstructed fairly accurately, which requires a longer code-length, hence acting as a counterbalance. Let f be the multiscale features input into the RNN, f′ be the reconstructed features, and L be the length of the sequence being transmitted. The loss function is given by Equation 3.

$${L}_{TR} = L {‖ f - {f}^{′} ‖}_{2}^{2} \qquad ( 3 )$$

Next, the overall network is trained in the following manner. The CNN-based feature encoder 562 is trained first and so is the RNN compression encoder 582 using the losses LMSE and LSIM respectively. After these sub-networks are pre-trained, the final network is trained overall with a combination of the losses, which is given by Equation 4.

$$\hat{L} = {λ}_{MSE} {L}_{MSE} + λ L + {λ}_{TR} {L}_{TR} \qquad ( 4 )$$

where λ_{MSE}, λ_{SIM}, and λ_{TR} depend on the dataset being used.

### 3.3 Example Performance Improvement

An experimental embodiment is compared with three other baselines in this section, i) model-based disjoint parameter selection and ii) joint data-driven parameter selection via NN and iii) Reinforcement Learning (RL). First, the experimental setup is presented, and then the baseline comparison is presented, and then further experiments on the technical intricacies of various embodiments are shown.

The performance of these embodiments is better than previous approaches using separately derived source coding and channel coding approaches, for a variety of such approaches. In the performance figures, the performance of an embodiment is given by traces labeled with an open diamond and the text “Deep JSCC.” The SNR is indicated in the performance plots by the ratio Eb/No, which is the energy per bit (Eb) divided by the noise (No).

We employ both simulations and real-life testbed experiments as conducted on Rutgers University, New Brunswick, NJ premises, to test our approach and compare against several baselines. Below we detail our setup for both the simulations and experimental setup. Simulations: In our simulations, the Rician channel is chosen to simulate the underwater channel. We set up this environment with the help of both MATLAB and Python. Underwater channel, source coding, channel coding, OFDM-based transmission, and channel estimation are all implemented in MATLAB while tuning algorithms are implemented in Python.

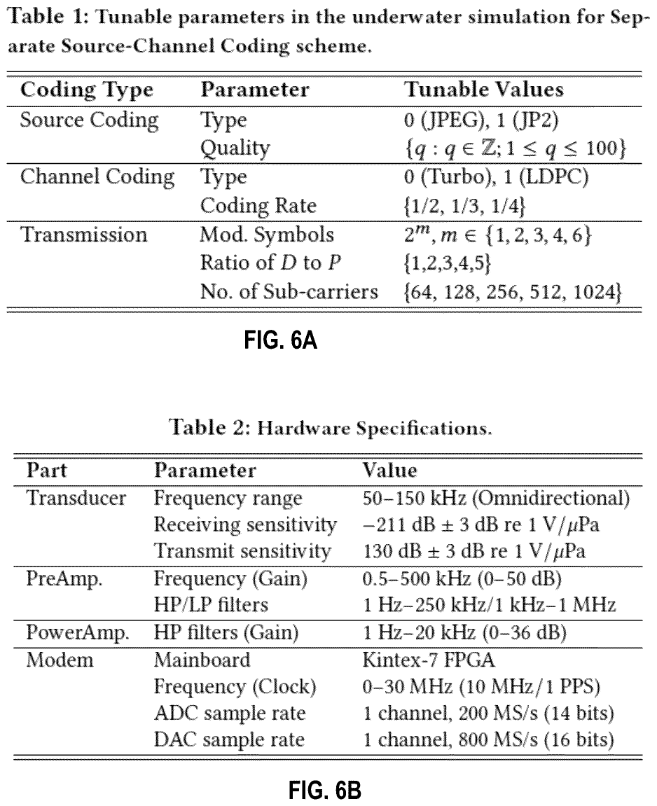

FIG. 6A and FIG. 6B are tables that list parameters used in simulation and experimental embodiments. Table 1 depicted in FIG. 6A shows the parameters that could be tuned in order to get the best data rate under a given channel condition during simulations. Looking at the total number of customizable parameters, one can see that there could be a total of 150,000 possible Separate Source Channel Coding (SSCC) schemes. In the parameters, modulation symbols denote how many bits are encoded in each symbol, with m=1 denoting the BPSK, m=2 denoting the QPSK scheme and so on. Furthermore, each OFDM frame is composed of both data symbols D and pilot symbols P. The ratio of D to P denotes how many data symbols are transmitted for each pilot symbol in a frame. A higher ratio means a low number of pilots and, hence, a weaker channel estimation at the receiver. Plotting the received bit error rate (BER) and peak signal to noise ratio (PSNR) of JPEG and JPEG 2000 with different channel coding methods in simulated Rician channels versus normalized SNR (Eb/No), one can observe that when BER is higher than 10⁻⁴, the received PSNR is very low and ‘cliff effects’ occur. One can also see that a low channel coding rate leads to low BER, and a high compression ratio leads to high PSNR. With the same compression ratio, the received image quality of JPEG 2000 is higher than that of JPEG, but the size of JPEG 2000 is larger than JPEG.

Based on these simulation results, embodiments were evaluated by conducting several rounds of pool experiments, based on a high-performance and scalable platform using a programmable Kintex-7 FPGA designed by Ettus Research Group with the NI Corporation, called Universal Software Radio Peripheral (USRP) X-300. Teledyne Marine RESON TC4013 omnidirectional transducers with a frequency range from 50 to 150 kiloHertz (kHz, 1 kHz=10³ Hertz, Hz) are used in this testbed. The specifications of the system are summarized in Table 2 depicted in FIG. 6A.

In these experiments, the transducer and the hydrophone are placed in a large pool as suspended from floats fixed to remain a predetermined distance apart at a predetermined depth. Test image data is passed to the acoustic modem and transducer to be sent to the hydrophone on the other side of the acoustic channel link. The transmit power is adjusted mutually by power amplifier to get different levels of SNR. The transmission is then done with the symbol rate of 100 kiloBaud (kBd, I kBd=10³ Baud). The BER and Peak Signal-to-Noise Ratio (PSNR) performance of JSCC in the pool shows that the results in pool experiments are very close to those in simulated Rician channels. To mitigate the multipath effect as well as to enhance the spectrum efficiency, the OFDM modulation is applied in the underwater transmissions. The OFDM FFT size is chosen to be 6144. Given a bandwidth of 100 kHz, the symbol rate is 100 kBd and the FFT duration is 6144/100=61.44 milliseconds (ms, 1 ms=10⁻³ seconds, s). The cyclic prefix length was chosen to be 10.24 ms. Overall the OFDM symbol length is 61.44+10.24=71.68 ms, and the subcarrier spacing is 1/71.68 ms=16.28 Hz.

For training the JSCC neural networks, both Underwater Image benchmark dataset and a large dataset of our own collected underwater images using BlueROVs in Raritan river, NJ, US were used. For all these experiments, the input image-size is always set to (200, 200, 3) and any images that do not conform to this size are resized using Python Imaging Library (PIL). Furthermore, the channel taps (with multiple paths contributing to multiple taps) estimated and collected during tests conducted at Sonny Werblin Recreation Center (see FIG. 2) were used for emulating the communication channel during training time.

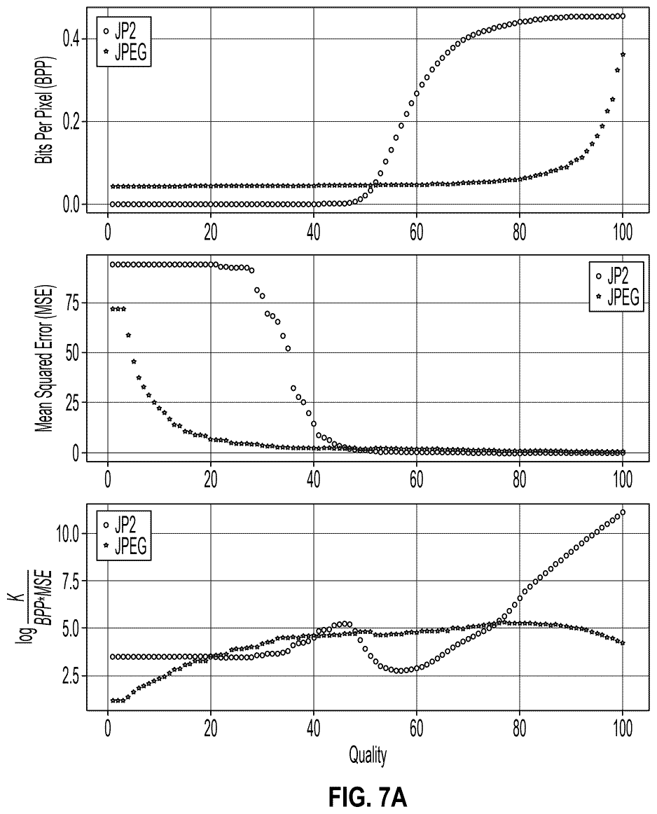

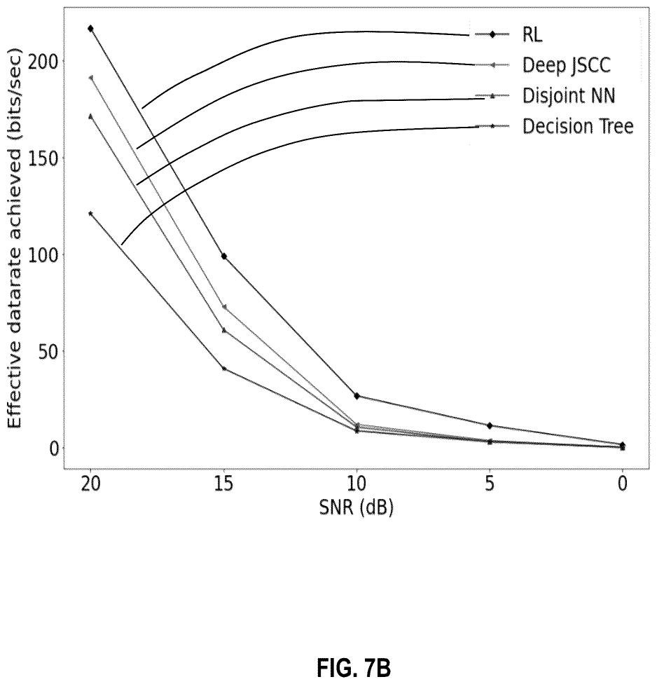

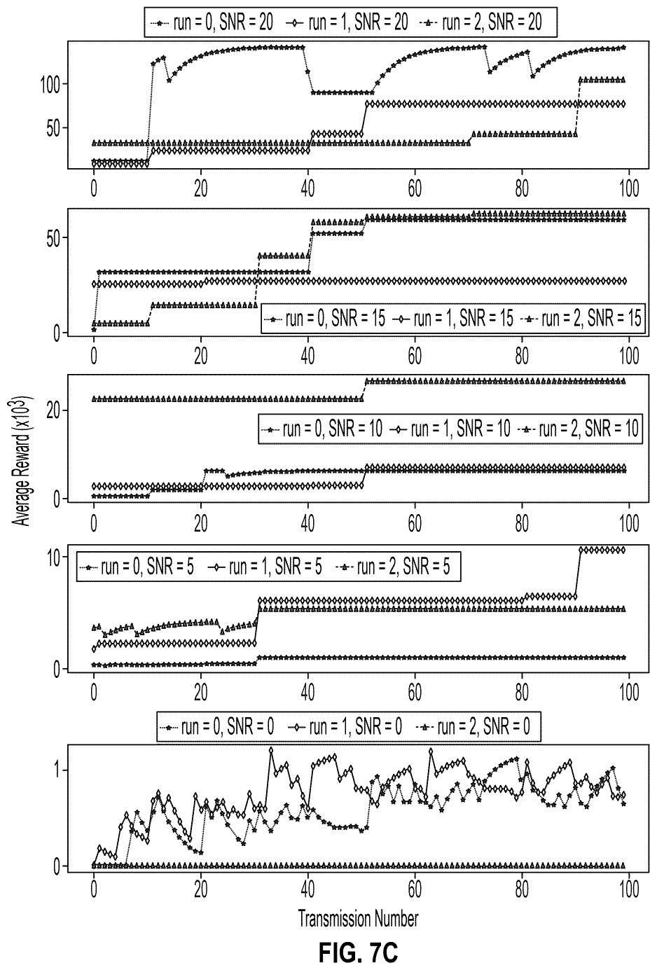

FIG. 7A through FIG. 7C are plots that illustrate examples of advantages over previous approaches, according to an embodiment.

In order to compare example embodiments to manual parameter selection which can be controlled by a tuner based on the feedback obtained from the receiver, this parameter selection problem was reconfigured as a classification problem. Hence, a decision-tree classifier was trained based on the approach presented in Konstantinos Pelekanakis, Luca Cazzanti, Giovanni Zappa, and João Alves. 2016 for the parameters stated in Table. 1. A dataset was generated with inputs of the dataset being CSI recovered from the above simulations, and the ground truth being the index of a possible permutation of the parameters, which gave the best data-rate given that 37 packets are transmitted. That scheme is then labelled as the ground truth, and the decision-tree classifier is trained on this dataset. FIG. 7B shows the comparison of a JSCC embodiment with other methods. The horizontal axis indicates signal to noise ratio (SNR) in deciBels (dB), and the vertical axis indicates effective data rate achieved in bits per second (bits/sec). The manual selection is represented by the trace labeled “Decision Tree.” The example embodiment of deep joint learning is labeled “Deep JSCC.” Each trace enjoys a high data rate at low signal to noise but decreases as SNR increases, but Decision Tree performs the worst of all. Note, in 7B, the x-axis is reversed, meaning that the SNR is decreasing to the right. Given that the number of output schemes is high, the decision-tree model performs poorly because of a lack of data and is not scalable as the number of available schemes increases.

A NN-based Disjoint Parameter Selection baseline, involves training a neural network classifier to predict the best-performing schemes for a given CSI, as proposed in Lihuan Huang, Yue Wang, Qunfei Zhang, Jing Han, Weijie Tan, and Zhi Tian, 2022. In this prior art scenario, 5 top performing schemes for a given SNR value were labelled as the ground truth in order to compensate for less available data and increase the probability of guessing a ‘good-enough’ scheme. The NN architecture used is the following: a convolutional Layer with 32 output filters, a kernel size of 5, and a sigmoid activation, another convolutional layer with 90 output filters and a kernel size of 5, a flatten layer and finally a dense layer with a Sigmoid activation predicting probabilities of each class. In FIG. 7B shows the comparison of this method labeled Disjoint NN with other methods. Similar to the Decision Tree model, this method is also not scalable as the number of available schemes increases, and does not perform as well as the Deep JSCC embodiment.

RL-based Disjoint Parameter Selection was also determined. Another way to design a link-tuning algorithm is to let it experiment directly on a live acoustic channel and then betters itself using the feedback it obtains using the average data-rate achieved and the BER, implicitly modelling the current channel conditions. This is the approach proposed by Shankar and Chitre, 2013, and it is used as a baseline for the JSCC embodiment. Since, the experimental setup is slightly different than the one described in the paper, it was adapted slightly to focus on only the Dynamic Programming (DP) based solution, because it outperforms all the rest approaches according to their evaluation. This reward function is directly proportional to the data-rate achieved by a given scheme. The reward R for transmitting a frame

$${s}_{i}^{P} ,$$

while being in state ξₜ at time t is given by Equation 5

$$R ( ξ t , sP i ) = α \hat{} ( j , c ) , t β j rcec . \qquad ( 5 )$$

$$R ( ξ t , {s}_{i}^{P} ) = {\hat{α}}_{( j , c ) , t} {β}_{j} {r}_{c} {e}_{c}$$

Here, ξₜ and

$${s}_{i}^{P} ,$$

namely agent's state and packet transmitted using scheme i, are defined in the same fashion as Shankar and Chitre, 2013. Furthermore, \hat{α}_{(j,c),t} denotes the estimated packet-success probability for a given scheme i=_{(j,c),β}_{ⱼ} denotes the uncoded data-rate, and r_{c} denotes the information rate of the channel-coding scheme being used. The agent in these plots is the process of Shankar and Chitre extended to incorporate image-related metrics to create a comparison trace.

One adaptation introduced by a current embodiment to this formula is the parameter e_{c}, which is defined as the compression-to-clarity ratio. Therefore, we define the compression-to-clarity ratio by Equation 6

$${e}_{c} = log [ \frac{K}{B P P \times M S E} ] \qquad ( 6 )$$

Where BPP is bits per pixel and K is a constant which controls the magnitude of the reward function. It is an empirical value, which makes sure that the resulting reward is within the desired numerical range for training/decision-making purposes. It does not change the relative values of the rewards. The distribution of this metric is shown in FIG. 7A where the performances of both codecs (JPEG, and JPEG2000 abbreviated JP2 in FIG. 7A) cross each other in the mid-quality area, while JPEG2000 ultimately provides better performance at higher quality values. The horizontal axis is Quality as exported by the JPEG decoder. FIG. 7C includes three stacked plots sharing a horizontal axis that indicates Quality and verticals axes that represent bits per pixel (BPP) on top, mean square error (MSE) in the middle, and the compression-to-clarity metric on the bottom. In 7C, the x-axis is not quality, but rather the transmission number. It is important as art by Shankar and Chitre requires multiple runs to maximize the data rate, and as evidenced by low SNR cases, it just keeps trying sometimes, and does not converge. Her is used K=10 for these results.

We use this final reward formula to update the Deep JSCC value function Vᵢ(ξₜ)) using the Bellman equation.: The performance of the Deep JSCC is shown in FIG. 7C where across multiple runs, Deep JSCC steadily increases performance. In lower SNR channels, the Deep JSCC does a lot of exploration, because of an overall lower probability of success, while at higher SNRs, the Deep JSCC does well with exploring the space and discovering schemes with higher rewards.

FIG. 7B also shows the comparison of Deep JSCC with other kinds of parameter selection. Overall, the RL method is scalable and adaptive but needs time to tune its reward functions. However, it may still result in sub-optimal performance as it only slowly explores the available search space. Furthermore, as shown in FIG. 7B the effective data rate achieved using all the different baselines are compared. It is observed that Deep JSCC scheme performs better than the disjoint NN and Decision Tree algorithms, while RL performs better than Deep JSCC. RL, however, takes a long time to converge for different SNR values (as shown in FIG. 7C while our approach achieves similar performance with a few transmissions. Note that Deep JSCC does not take multiple attempts to converge and is rather one-shot in its approach. Combining this information with 7B shows that even with one-shot operation, Deep JSCC performs nearly as well as the slower to converge RL (which is modified Shankar and Chitre).

### 3. Computational Hardware Overview

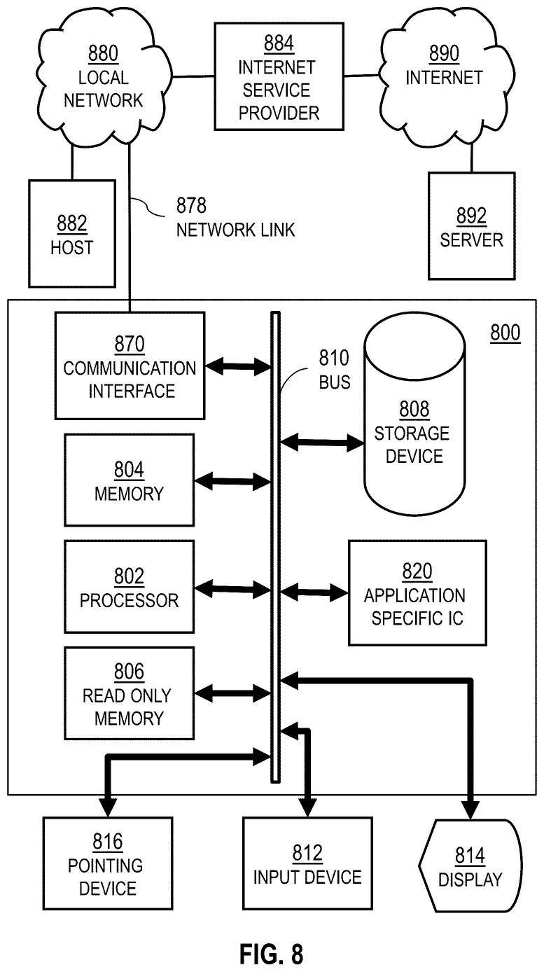

FIG. 8 is a block diagram that illustrates a computer system 800 upon which an embodiment of the invention may be implemented. Computer system 800 includes a communication mechanism such as a bus 810 for passing information between other internal and external components of the computer system 800. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of one or more methods described herein.

A sequence of binary digits constitutes digital data that is used to represent a number or code for a character. A bus 810 includes many parallel conductors of information so that information is transferred quickly among devices coupled to the bus 810. One or more processors 802 for processing information are coupled with the bus 810. A processor 802 performs a set of operations on information. The set of operations include bringing information in from the bus 810 and placing information on the bus 810. The set of operations also typically include comparing two or more units of information, shifting positions of units of information, and combining two or more units of information, such as by addition or multiplication. A sequence of operations to be executed by the processor 802 constitutes computer instructions.

Computer system 800 also includes a memory 804 coupled to bus 810. The memory 804, such as a Random Access Memory (RAM) or other dynamic storage device, stores information including computer instructions. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of computer instructions. The computer system 800 also includes a Read Only Memory (ROM) 806 or other static storage device coupled to the bus 810 for storing static information, including instructions, that is not changed by the computer system 800. Also coupled to bus 810 is a non-volatile (persistent) storage device 808, such as a magnetic disk or optical disk, for storing information, including instructions, that persists even when the computer system 800 is turned off or otherwise loses power.

Information, including instructions, is provided to the bus 810 for use by the processor from an external input device 812, such as a keyboard containing alphanumeric keys operated by a human user, or a sensor. A sensor detects conditions in its vicinity and transforms those detections into signals compatible with the signals used to represent information in computer system 800. Other external devices coupled to bus 810, used primarily for interacting with humans, include a display device 814, such as a cathode ray tube (CRT) or a liquid crystal display (LCD), for presenting images, and a pointing device 816, such as a mouse or a trackball or cursor direction keys, for controlling a position of a small cursor image presented on the display 814 and issuing commands associated with graphical elements presented on the display 814.

In the illustrated embodiment, special purpose hardware, such as an application specific integrated circuit (IC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 870 sends and receives electrical, acoustic or electromagnetic signals, including infrared and optical signals, that carry information streams, such as digital data.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 802, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 802, except for carrier waves and other signals.

Logic encoded in one or more tangible media includes one or both of processor instructions on a computer-readable storage media and special purpose hardware, such as ASIC 820.

Network link 878 typically provides information communication through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890. A computer called a server 892 connected to the Internet provides a service in response to information received over the Internet. For example, server 892 provides information representing video data for presentation at display 814.

The invention is related to the use of computer system 800 for implementing the techniques described herein. According to one embodiment of the invention, those techniques are performed by computer system 800 in response to processor 802 executing one or more sequences of one or more instructions contained in memory 804. Such instructions, also called software and program code, may be read into memory 804 from another computer-readable medium such as storage device 808. Execution of the sequences of instructions contained in memory 804 causes processor 802 to perform the method steps described herein. In alternative embodiments, hardware, such as application specific integrated circuit 820, may be used in place of or in combination with software to implement the invention. Thus, embodiments of the invention are not limited to any specific combination of hardware and software.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server 892 transmits program code for a particular application, requested by a message sent from computer 800, through Internet 890, ISP equipment 884, local network 880 and communications interface 870. The received code may be executed by processor 802 as it is received, or may be stored in storage device 808 or other non-volatile storage for later execution, or both. In this manner, computer system 800 may obtain application program code in the form of a signal on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red a carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

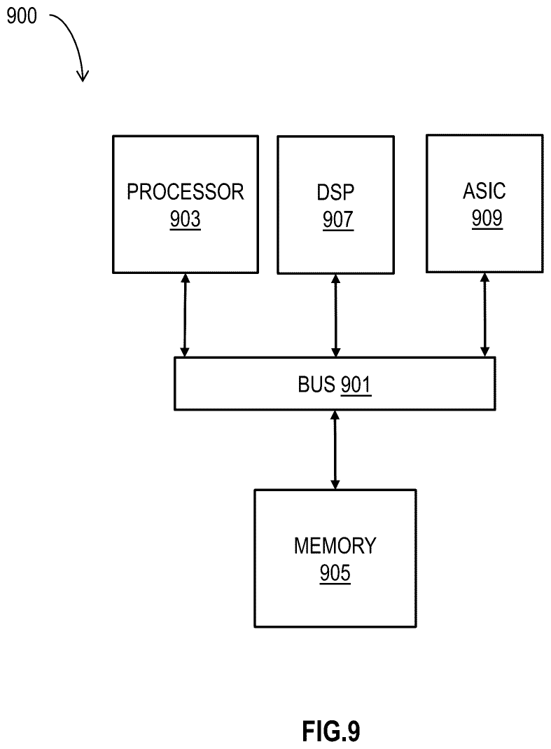

FIG. 9 illustrates a chip set 900 upon which an embodiment of the invention may be implemented. Chip set 900 is programmed to perform one or more steps of a method described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of a method described herein.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 905 also stores the data associated with or generated by the execution of one or more steps of the methods described herein.

### 4. Alternatives, Deviations and Modifications

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” for a positive only parameter can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

### 5. REFERENCES

All the references listed here are hereby incorporated by reference as if fully set forth herein except for terminology inconsistent with that used herein.
1. [n.d.]. RESON TC4013 Hydrophone Product Information. http://www.teledynemarine.com/reson-tc4013. Accessed Feb. 2, 2021.
2. [n.d.]. USRP X Series. https://www.ettus.com. Accessed Feb. 2, 2021.
3. Hiroaki Akutsu, Akifumi Suzuki, Zhisheng Zhong, and Kiyoharu Aizawa. 2020. Ultra Low Bitrate Learned Image Compression by Selective Detail Decoding. In 2020 IEEE/CVF Conference on Computer Vision and Pattern Recognition Workshops (CVPRW). IEEE, Seattle, WA, USA, 524-528. https://ieeexplore.ieee.org/document/9150712/4.
4. Khizar Anjum, Zhile Li, and Dario Pompili. 2022. Acoustic Channel-aware Autoencoder-based Compression for Underwater Image Transmission. In The Sixth Underwater Communications and Networking Conference (UComms). 1-4. [5] Johannes Ballé, Valero Laparra, and Eero P Simoncelli. 2015. Density modeling of images using a generalized normalization transformation. arXiv preprint arXiv: 1511.06281 (2015).
6. Yuting Bao, Yuwen Tao, and Pengjiang Qian. 2022. Image Compression Based on Hybrid Domain Attention and Postprocessing Enhancement. Computational Intelligence and Neuroscience 2022 (March 2022), 1-12. https://www.hindawi. com/journals/cin/2022/4926124/7.
7. Eirina Bourtsoulatze, David Burth Kurka, and Deniz Gündüz. 2019. Deep Joint Source-Channel Coding for Wireless Image Transmission. IEEE Transactions on Cognitive Communications and Networking 5, 3 (September 2019), 567-579. Conference Name: IEEE Transactions on Cognitive Communications and Networking.
8. Zhengxue Cheng, Ting Fu, Jiapeng Hu, Li Guo, Shihao Wang, Xiongxin Zhao, Dajiang Zhou, and Yang Song. 2021. Perceptual Image Compression using Relativistic Average Least Squares GANs. In 2021 IEEE/CVF Conference on Computer Vision and Pattern Recognition Workshops (CVPRW). IEEE, Nashville, TN, USA, 1895-1900. https://ieeexplore.ieee.org/document/9522791/9.
9. IEEE Computer Society LAN/MAN Standards Committee et al. 2007. IEEE Standard for Information Technology-Telecommunications and information exchange between systems-Local and metropolitan area networks-Specific requirements Part 11: Wireless LAN Medium Access Control (MAC) and Physical Layer (PHY) Specifications. IEEE Std 802.11 (2007).
10. Henry Dol, Koen Blom, Paul van Walree, Roald Otnes, Håvard Austad, Till Wiegand, and Dimitri Sotnik. 2020. Adaptivity at the Physical Layer. In Cognitive Underwater Acoustic Networking Techniques, Dimitri Sotnik, Michael Goetz, and Ivor Nissen (Eds.). Springer Berlin Heidelberg, Berlin, Heidelberg, 13-40.
11. Iñaki Estella Aguerri and Deniz Gündüz. 2016. Joint Source-Channel Coding With Time-Varying Channel and Side-Information. IEEE Transactions on Information Theory 62, 2 (February 2016), 736-753. Conference Name: IEEE Transactions on Information Theory.
12. Fredrik Hekland, Pal Anders Floor, and Tor A. Ramstad. 2009. Shannon-kotelnikov mappings in joint source-channel coding. IEEE Transactions on Communications 57, 1 (2009), 94-105.
13. Lihuan Huang, Yue Wang, Qunfei Zhang, Jing Han, Weijie Tan, and Zhi Tian. 2022. Machine Learning for Underwater Acoustic Communications. IEEE Wireless Communications (2022), 1-8. Conference Name: IEEE Wireless Communications.
14. Lihuan Huang, Qunfei Zhang, Weijie Tan, Yue Wang, Lifan Zhang, Chengbing He, and Zhi Tian. 2020. Adaptive modulation and coding in underwater acoustic communications: a machine learning perspective. EURASIP Journal on Wireless Communications and Networking 2020, 1 (October 2020), 203.
15. Hovannes Kulhandjian and Tommaso Melodia. 2014. Modeling Underwater Acoustic Channels in Short-Range Shallow Water Environments. In Proceedings of the International Conference on Underwater Networks & Systems (Rome, Italy). 1-5.
16. David Burth Kurka and Deniz Gündüz. 2020. DeepJSCC-f: Deep Joint Source-Channel Coding of Images with Feedback. Technical Report arXiv: 1911.11174. arXiv. http://arxiv.org/abs/1911.11174 arXiv: 1911.11174 [cs, eess, math, stat] type: article.
17. Chongyi Li, Chunle Guo, Wenqi Ren, Runmin Cong, Junhui Hou, Sam Kwong, and Dacheng Tao. 2019. An underwater image enhancement benchmark dataset and beyond. IEEE Transactions on Image Processing 29 (2019), 4376-4389.
18. Fabian Mentzer, George Toderici, Michael Tschannen, and Eirikur Agustsson. 2020. High-Fidelity Generative Image Compression. Technical Report arXiv: 2006.09965. arXiv. http://arxiv.org/abs/2006.09965 arXiv: 2006.09965 [cs,eess] type: article.
19. Konstantinos Pelekanakis, Luca Cazzanti, Giovanni Zappa, and João Alves. 2016. Decision tree-based adaptive modulation for underwater acoustic communications. In 2016 IEEE Third Underwater Communications and Networking Conference (UComms). 1-5.
20. Roberto Petroccia, Pietro Cassarà, and Konstantinos Pelekanakis. 2019. Optimizing Adaptive Communications in Underwater Acoustic Networks. In OCEANS 2019 MTS/IEEE SEATTLE. 1-7. ISSN: 0197-7385.
21. Andreja Radosevic, Rameez Ahmed, Tolga M. Duman, John G. Proakis, and Milica Stojanovic. 2014. Adaptive OFDM Modulation for Underwater Acoustic Communications: Design Considerations and Experimental Results. IEEE Journal of Oceanic Engineering 39, 2 (April 2014), 357-370. Conference Name: IEEE Journal of Oceanic Engineering.
22. Andreja Radosevic, John G. Proakis, and Milica Stojanovic. 2009. Statistical characterization and capacity of shallow water acoustic channels. In OCEANS 2009-EUROPE. 1-8.
23. Satish Shankar and Mandar Chitre. 2013. Tuning an underwater communication link. In 2013 MTS/IEEE OCEANS-Bergen. 1-9.
24. Claude Elwood Shannon. 1948. A mathematical theory of communication. The Bell system technical journal 27, 3 (1948), 379-423.
25. Ilya Sutskever, Oriol Vinyals, and Quoc V. Le. 2014. Sequence to Sequence Learning with Neural Networks. https://arxiv.org/abs/1409.3215
26. D. S. Taubman and M. W. Marcellin. 2002. JPEG2000: standard for interactive imaging. Proc. IEEE 90, 8 (August 2002), 1336-1357. Conference Name: Proceedings of the IEEE.
27. Tze-Yang Tung, David Burth Kurka, Mikolaj Jankowski, and Deniz Gunduz. 2022. DeepJSCC-Q: Constellation Constrained Deep Joint Source-Channel Coding. arXiv preprint arXiv: 2206.08100 (2022).
28. Paul A. van Walree. 2013. Propagation and Scattering Effects in Underwater Acoustic Communication Channels. IEEE Journal of Oceanic Engineering 38, 4 (2013), 614-631.
29. S. Vembu, S. Verdu, and Y. Steinberg. 1995. The source-channel separation theorem revisited. IEEE Transactions on Information Theory 41, 1 (1995), 44-54.
30. G. K. Wallace. 1992. The JPEG still picture compression standard. IEEE Transactions on Consumer Electronics 38, 1 (February 1992), xviii-xxxiv. Conference Name: IEEE Transactions on Consumer Electronics.
31. Zhou Wang, A. C. Bovik, H. R. Sheikh, and E. P. Simoncelli. 2004. Image quality assessment: from error visibility to structural similarity. IEEE Transactions on Image Processing 13, 4 (2004), 600-612.
32. Jialong Xu, Bo Ai, Ning Wang, and Wei Chen. 2022. Deep Joint Source-Channel Coding for CSI Feedback: An End-to-End Approach. Technical Report arXiv: 2203.16005. arXiv. http://arxiv.org/abs/2203.16005 arXiv: 2203.16005 [cs, eess, math] type: article.
33. Jintao Yan, Jianhao Huang, and Chuan Huang. 2021. Deep Learning Aided Joint Source-Channel Coding for Wireless Networks. In 2021 IEEE/CIC International Conference on Communications in China (ICCC). 805-810. ISSN: 2377-8644.

What is claimed is:

1. A non-transitory computer-readable medium carrying one or more sequences of instructions for underwater communications, wherein execution of the one or more sequences of instructions by one or more processors causes the one or more processors to perform the steps of:
retrieving from a computer-readable medium first data that indicates a model that comprises a multilayer convolution neural network encoder and an underwater acoustic channel transform and a multilayer convolution neural network decoder, which model is trained on a training set including for each instance input image data and input acoustic channel information data such that output image data is sufficiently similar to the input image data for a particular purpose;
receiving second data that indicates image data and input acoustic channel information data;
generating third data that indicates output of the encoder of the first data operating on the second data; and
sending an underwater acoustic signal that indicates the third data.

2. A non-transitory computer-readable medium as recited in claim 1, wherein the multilayer convolution neural network encoder further includes an encoding long short-term memory recurrent neural network and the multilayer convolution neural network decoder further includes a decoding long short-term memory recurrent neural network.

3. A non-transitory computer-readable medium as recited in claim 1, wherein each instance input image data depicts an underwater scene.

4. A non-transitory computer-readable medium as recited in claim 1, wherein each instance input acoustic channel information data indicates an amplitude shift and phase shift for each of one or more frequency shifts from a carrier acoustic frequency.

5. A non-transitory computer-readable medium as recited in claim 1, wherein each instance input acoustic channel information data indicates a numbered transceiver circuit tap for each of one or more frequency shifts from a carrier acoustic frequency.

6. A non-transitory computer-readable medium as recited in claim 1, wherein execution of the one or more sequences of instructions further causes the one or more processors to perform the steps of:
receiving a second underwater acoustic signal that indicates fourth data; and
generating fifth data that indicates image data based on output of the decoder of the first data operating on the fourth data.

7. An apparatus for underwater communications comprising:
an acoustic transceiver;
at least one processor; and
at least one memory including one or more sequences of instructions,
the at least one memory and the one or more sequences of instructions configured to, with the at least one processor, cause the apparatus to perform at least the following,
retrieving from a computer-readable medium first data that indicates a model that includes a multilayer convolution neural network encoder and an underwater acoustic channel transform and a multilayer convolution neural network decoder, which model is trained on a training set including for each instance input image data and input acoustic channel information data such that output image data is sufficiently similar to the input image data for a particular purpose;
receiving second data that indicates image data and input acoustic channel information data;
generating third data that indicates output of the encoder of the first data operating on the second data; and
sending an underwater acoustic signal that indicates the third data.

8. A system for underwater communications comprising two or more underwater devices each comprising the apparatus of claim 7.

9. A method for underwater acoustic communications, comprising:
training automatically on a processor a model that comprises a multilayer convolution neural network encoder and an underwater acoustic channel transform and a multilayer convolution neural network decoder, which model is trained on a training set including for each instance input image data and input acoustic channel information data such that output image data is sufficiently similar to the input image data for a particular purpose;
sending first data that indicates the model to a processor on a underwater device that comprises an underwater acoustic transceiver, wherein the underwater device is configured to perform at least the steps of:
receiving second data that indicates image data and input acoustic channel information data;
generating third data that indicates output of the encoder of the first data operating on the second data; and
sending the third data to the underwater acoustic transceiver.
